(19) United States
(12) Patent Application Publication
(10) Pub. No.: US 2005/0060217 A1
(43) Pub. Date: Mar. 17, 2005

(54) Customer service support system

(76) Inventors: James Douglas, Birdsboro, PA (US); Joe Antonini, Collegeville, PA (US); James Tatasciore, Media, PA (US); Raymond E. Bonnett, West Chester, PA (US)

Correspondence Address: Alexander J. Burke, 170 Wood Avenue South, Intellectual Property Department 5th Floor, Iselin, NJ, 08830, US

(21) Appl. No.: 10/928,822

(22) Filed: Aug. 27, 2004

Related U.S. Application Data
(60) Provisional application No. 60/498,946, filed on Aug. 29, 2003.

(51) Int. Cl. G06F 17/60

(52) U.S. Cl. 705/9

(57) ABSTRACT

A system for processing data identifying issues including problems comprises an input processor, an issue processor, and a task scheduling processor. The input processor receives issue identification data identifying a type of issue to be processed. The issue processor parses the issue identification data, and associates a product category with the type of issue based on parsed issue identification data. The task scheduling processor assigns a worker to attend to the issue in response to the product category, and initiates generation of a record of the assignment.

### CROSS-REFERENCE TO RELATED APPLICATIONS

The present application is a non-provisional application of provisional application having Ser. No. 60/498,946 filed by James Douglas, et al. on Aug. 29, 2003.

### FIELD OF THE INVENTION

The present invention generally relates to information systems. More particularly, the present invention relates to a customer service support system.

### BACKGROUND OF THE INVENTION

Known information systems respond to problems by allocating and managing staff and resources in a reactive manner, which is typically a manual, time consuming, and inefficient process.

Known information systems typically employ subjective criteria in trying to manage personnel having personal obligations and preferences, which results in less than optimal matching of issues with staff and resources and compromised system efficiency.

Known information systems employ manual personnel management methods and reporting, which are cumbersome and time consuming in operation and do not anticipate or accommodate multiple variables effecting workload changes.

Accordingly, there is a need for a customer service support system that overcomes these and other disadvantages of the known systems.

### SUMMARY OF THE INVENTION

A system for processing data identifying issues including problems comprises an input processor, an issue processor, and a task scheduling processor. The input processor receives issue identification data identifying a type of issue to be processed. The issue processor parses the issue identification data, and associates a product category with the type of issue based on parsed issue identification data. The task scheduling processor assigns a worker to attend to the issue in response to the product category, and initiates generation of a record of the assignment.

### BRIEF DESCRIPTION OF THE DRAWINGS

FIG. 1 illustrates a customer service support system, in accordance with a preferred embodiment of the present invention.

FIG. 2 illustrates a customer service support method for the system, as shown in FIG. 1, in accordance with a preferred embodiment of the present invention.

FIG. 3 illustrates a dynamic staff allocation system incorporating the system,.as shown in FIG. 1, in accordance with a preferred embodiment of the present invention.

FIG. 4 illustrates a staffing model report request displayed by the display, as shown in FIG. 1, in accordance with a preferred embodiment of the present invention.

FIG. 5 illustrates a staffing model by process report displayed by the display, as shown in FIG. 1, in accordance with a preferred embodiment of the present invention.

FIG. 6 illustrates a staffing backlog report displayed by the display, as shown in FIG. 1, in accordance with a preferred embodiment of the present invention.

FIG. 7 illustrates a work statistic and schedule request displayed by the display, as shown in FIG. 1, in accordance with a preferred embodiment of the present invention.

FIG. 8 illustrates a work schedule by process report displayed by the display, as shown in FIG. 1, in accordance with a preferred embodiment of the present invention.

FIG. 9 illustrates a work schedule by employee report displayed by the display, as shown in FIG. 1 in accordance with a preferred embodiment of the present invention.

FIG. 10 illustrates an employee status by manager identifier displayed by the display, as shown in FIG. 1, in accordance with a preferred embodiment of the present invention.

FIG. 11 illustrates an employee competency self-evaluation displayed by the display, as shown in FIG. 1, in accordance with a preferred embodiment of the present invention.

FIG. 12 illustrates an employee competency rating and verification report displayed by the display, as shown in FIG. 1, in accordance with a preferred embodiment of the present invention.

FIG. 13 illustrates a performance impact calculation report displayed by the display, as shown in FIG. 1, in accordance with a preferred embodiment of the present invention.

FIG. 14 illustrates a performance review report displayed by the display, as shown in FIG. 1, in accordance with a preferred embodiment of the present invention.

FIG. 15 illustrates a customer work request displayed by the display, as shown in FIG. 1, in accordance with a preferred embodiment of the present invention.

FIG. 16 illustrates a customer update request to add comments displayed by the display, as shown in FIG. 1, in accordance with a preferred embodiment of the present invention.

FIG. 17 illustrates a customer update to request escalation displayed by the display, as shown in FIG. 1, in accordance with a preferred embodiment of the present invention.

FIG. 18 illustrates a customer update request to respond to approval displayed by the display, as shown in FIG. 1, in accordance with a preferred embodiment of the present invention.

FIG. 19 illustrates a customer update request to close issue displayed by the display, as shown in FIG. 1, in accordance with a preferred embodiment of the present invention.

FIG. 20 illustrates a customer request monitor displayed by the display, as shown in FIG. 1, in accordance with a preferred embodiment of the present invention.

### DETAILED DESCRIPTION OF THE PREFERRED EMBODIMENTS

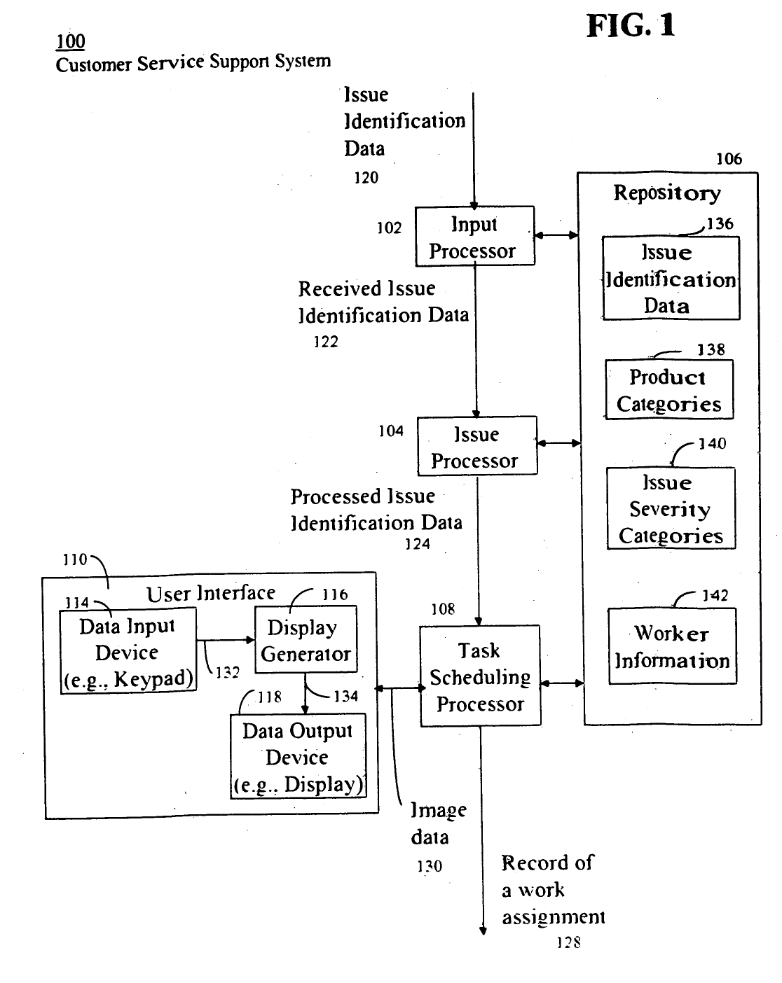

FIG. 1 illustrates a customer service support system (“system”) 100. The system 100 includes an input processor 102, an issue processor 104, a repository 106, a task scheduling processor 108, and a user interface 110. The repository 106 further includes issue identification data 136, product categories 138, issue severity categories 140, and worker information 142. The user interface 110 further includes a data input device 1 14, a display generator 116, and a data output device 118.

The system 100 may by used by any type of enterprise, and is intended for use by a healthcare provider that is responsible for servicing the health and/or welfare of people in its care. A healthcare provider may provide services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, and a dental office. When servicing a person in its care. a healthcare provider diagnoses a condition or disease, and recommends a course of treatment to cure the condition, if such treatment exists, or provides preventative healthcare services. Examples of the people being serviced by a healthcare provider include a patient, a resident, a client, a user, and an individual.

The system 100 processes data identifying issues, including problems, related to any aspect of the enterprise, which need to be addressed by resources. The resources include, for example, human resources, such as personnel, employees, contractors, workers, or other staff.

The repository 106 represents a data storage element and may otherwise be called a memory device, a storage device, a database, etc. The database may be of any type including for example, a Microsoft® (MS) Access® database.

The input processor 102 represents any type of communication interface that receives any type of signal, such as issue identification data 120 identifying a type of issue to be processed, and generates received issue identification data 122.

A customer of the enterprise may provide the issue identification data to the system 100. In this case, system 100 receives the issue identification data 120 via a communication network from the customer. The issue identification data includes data identifying one or more of: (a) a product name, (b) nature of a problem with the product, (c) a type of the product, (d) whether the issue is related to hardware or software, (e) a severity level of the issue, (f) a category identifying impact level on the customer, (g) existence of a warranty held by the customer and associated with the product, (h) a warranty type held by the customer and associated with the product, and (i) existence of a service contract held by the customer and associated with the product. The system 100 advantageously permits the enterprise to efficiently assign a worker to respond to and resolve the customer's issue.

Alternatively, the system 100 receives the issue identification data 120 from the repository 106. In this case, the issues may be related to an enterprise's problems or needs, and the system 100 supports the enterprises own internal customers.

The issue processor 104 parses the received issue identification data 122, and associates a product category 138 and/or an issue severity category 140 with the type of issue based on parsed issue identification data to generate processed issue identification data 124. Parsing may otherwise be called dissecting, separating, distinguishing, identifying, categorizing, sorting, etc.

Alternatively, the repository 106 may contain the issue identification data 136 identifying multiple individual issues to be processed, and associate the product category 138 and/or the issue severity category 140 with each individual issue. In this case, the input processor 102 and the issue processor 104 may not be needed or may be used to create the association in the repository 106.

The task scheduling processor 108 dynamically assigns a worker or a group of workers (or re-assign a worker to one group to another) to attend to the issue in responsee to the product category 138 and/or the issue severity category 140 and in response to worker information 142, and initiates generation of a record of the assignment 128. The task scheduling processor 108 also generates image data 130 for use by the user interface 110.

The task scheduling processor 108 automatically updates a task schedule, indicating tasks the worker is responsible for, in order to indicate that the worker is to attend to the issue.

The task scheduling processor stores the generated record of the assignment in memory and/or communicates the generated record of the assignment to a recipient. The record of the assignment 128 may be communicated to one or more of the following: (a) a display on a reproduction device (e.g., the data output device 118), (b) communication to a remote system, and (c) print output (e.g., the data output device 118). The record of the assignment 128 may be the same or different than the image data 130 communicated to the user interface 110.

The task scheduling processor 108 assigns a particular worker to attend to the issue in response to an indicator representing one or more of: (a) the issue severity category 140, (b) training of the particular worker. (c) experience of the particular worker, (d) skill of the particular worker, (e) a proficiency level of the particular worker, (f) a schedule of the particular worker, (g) credentials of the particular worker, and (h) workload of the particular worker.

The task scheduling processor 108 assigns a particular worker to attend to the issue in response to an indicator representing one or more of: (a) seasonal workload variation, (b) a current time or date, and (c) prior successful issue resolution metric of a particular worker.

The task scheduling processor 108 may also make the assignment in, response to different factors in addition to the product category 138 and/or the issue severity category 140. The different factors include one or more of the following: (a) an indicator representing a number of issues requiring attention, (b) an indicator representing a change in a number of issues requiring attention, (c) an indicator representing a change in severity level of issues, (d) an indicator representing a change in time required to resolve issues, (e) an indicator representing change in skill level of at least one of the plurality of different workers, and (f) an indicator representing a seasonal variation. The different factors may also include (a) an indicator representing a change in number of customers, and/or (b) an indicator representing a change in customer activity. Alternatively, the task scheduling processor 108 may make the assignment in response to an indicator associated with one or more of the following: a) a severity level of the particular issue, b) an indicator associated with a proficiency level of a worker, c) a number of issues requiring attention, d) time required to resolve issues, and e) seasonal work load variation.

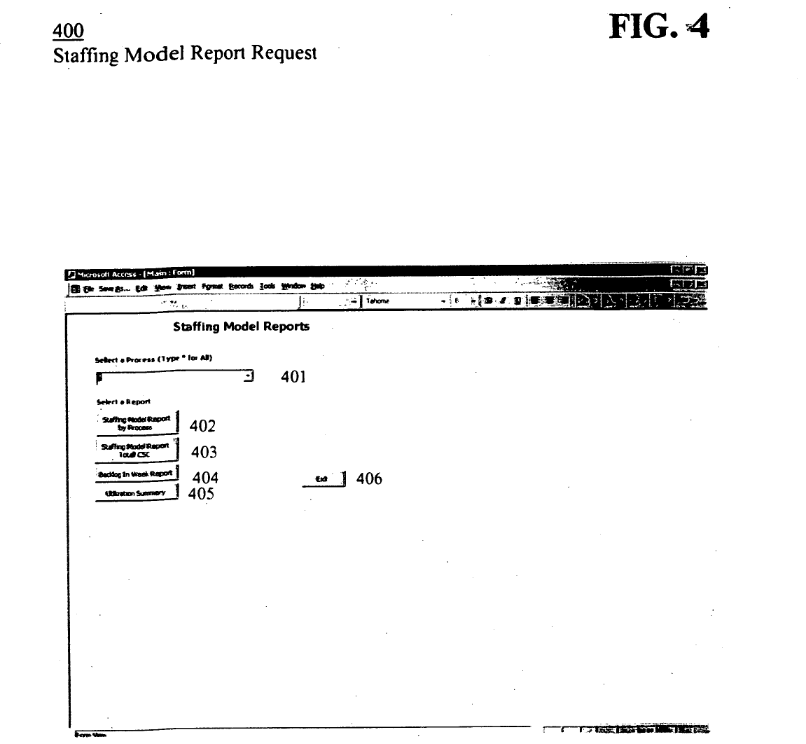

The user interface 110 permits a user to interact with the system 100 by inputting data into the system 100 and/or receiving data from the system 100. The user interface 110 generates one or more display images, as shown in FIGS. 4-20, for example.

The data input device 114 provides input data 132 to the display generator 116 in response to receiving input information either manually from a user or automatically from an electronic device. The data input device 114 is a keyboard, but also may be a touch screen, or a microphone with a voice recognition program, for example.

The display generator 116 generates display signals 134, representing one or more images for display, in response to receiving the input data 132 or other data from the system 100, such as the image data 130 from the task scheduling processor 108. Such other data from the system 100 may include one or more of the following: (a) associated issue severity category information, (b) information identifying a number of workers assigned to attend to the identified issues, (c) information identifying individual workers assigned to attend to the identified issues, and (d) information identifying issues collated by associated product category.

The display image presents information that identifies issues received for processing during a user selected time period in response to a user command. The user selected time period includes one or more of the following: (a) a day, (b) a week, and (c) a month.

The display generator 116 initiates generation of data representing a display image enabling a user to select one or more of the following: (a) automatic assignment of a worker to attend to an issue, (b) a prompt to a user to initiate assignment of a worker to attend to an issue, (c) a threshold comprising a number of issues for use in triggering issue re-assignment, and (d) frequency at which a report identifying worker workload is to be generated.

The display generator 116 is a known element including electronic circuitry or software or a combination of both for generating display images or portions thereof. The image for display may include any information stored in the repository 106 and any information shown in FIGS. 4-20. An action by a user, such as, for example, an activation of a displayed button, may cause the image to be displayed.

The data output device 118 represents any type of element that generates data. The data output device 118 is a display that generates display images, as shown in FIGS. 4-20, in response to receiving the display signals 134, but also may be a speaker or a printer, for example.

The user interface 110 provides a graphical user interface (GUI), as shown in FIGS. 4-20, for example, wherein portions of the data input device 114 and portions of the data output device 118 are integrated together to provide a user-friendly interface. The GUI may have any type of format, layout, user interaction, etc., as desired, and should not be limited to that shown in FIGS. 4-20. In an exemplary embodiment, the GUI is formed as a web browser, as shown in FIGS. 1-13, and 19.

In the system 100, one or more elements may be implemented in hardware, software, or a combination of both. Further, one or more elements may include one or more processors, such as the input processor 102, the issue processor 104, the task scheduling processor 108, and the display generator 16. A processor includes any combination of hardware, firmware, and/or software. A processor acts upon stored and/or received information by computing, manipulating, analyzing, modifying, converting, or transmitting information for use by an executable procedure or an information device, and/or by routing the information to an output device. For example, a processor may use or include the capabilities of a controller or microprocessor.

A processor performs tasks in response to processing an object. An object comprises a grouping of data and/or executable instructions, an executable procedure, or an executable application. An executable application comprises code or machine readable instruction for implementing predetermined functions including those of an operating system, healthcare information system, or other information processing system, for example, in response user command or input.

The system 100 may be fixed or mobile (i.e., portable), and may be implemented in a variety of forms including a personal computer (PC), a desktop computer, a laptop computer, a workstation, a network-based device, a personal digital assistant (PDA), a smart card, a cellular telephone, a pager, and a wristwatch. The system 100 may be implemented in a centralized or decentralized configuration.

The system 100 provides an electronic mechanism for a healthcare provider to identify healthcare information representing issues, including problems, and to assign a worker to attend to the issue. The healthcare information may be represented in a variety of file formats including numeric files, text files, graphic files, video files, audio files, and visual files. The graphic files include a graphical trace including, for example, an electrocardiogram (ECG) trace, and an electroencephalogram (EEG) trace. The video files include a still video image or a video image sequence. The audio files include an audio sound or an audio segment. The visual files include a diagnostic image including, for example, a magnetic resonance image (MRI), an X-ray, a positive emission tomography (PET) scan, or a sonogram.

The system 100 communicates with remote computer systems over a wired or wireless communication path, otherwise called a network, a link, a channel, or a connection. The communication path may use any type of protocol or data format including an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, an Institute Of Electrical And Electronic Engineers (IEEE) bus compatible protocol, a Digital and Imaging Communications (DICOM) protocol, and a Health Level Seven (HL7) protocol.

The system 100 advantageously improves personnel management and customer service responsiveness for an enterprise and reduces delays appropriate staff allocation that causes increased workload, increased issue resolution cycle time, and decreased in customer satisfaction. The system 100 advantageously employs objective measurements and pre-determined control limits instead of subjective personnel management and scheduling criteria to assign a worker to an issue.

The system 100 processes problem and issue identification information for facilitating resolution of customer support issues and to balance human resources across an organization in a real-time manner. The system 100 detects staffing imbalances and re-allocates or requests staff movement according to workload trends reflecting one or more of the following:
a) seasonal patterns;
b) increases or decreases in the number of customers;
c) increased or decreased customer activity;
d) increases or decreases in issues requiring intervention;
e) increases or decreases in the severity of reported issues;
f) increases or decreases in the actual time and cycle time required to resolve issues of a given severity; and
g) changes in the skill level of the problem resolution staff.

The system 100 receives a stream of data identifying incoming issues, such as problems identified by customers, for example. The issue data and underlying issues are electronically monitored, evaluated, graded, and stored. Historical experience coupled with staff credentials and schedules are used to measure current imbalances and forecast future needs. The issues and staff are categorized by product line and product, as well as severity, to match the issue workload to qualified skilled personnel.

The system 100 automates continuing evaluation and analysis required to identify resource re-allocation requirements and reduces deterioration in business process results derived from delays in issue and problem processing in customer service operation. The system 100 displays user interface images indicating changes in both cycle time (elapsed time) and work time for each product category 138 and/or severity category 140. The system 100 uses past seasonal patterns and forecasts of changing customer demand to anticipate changes in hiring, scheduling, and training. The system 100 may also be used in special circumstances such as start-up or new enterprises, which exhibit different behaviors than more established enterprises.

The system 100 provides an expert system that automatically evaluates in real-time incoming and backlogged issues assigns a product category 138 and/or a severity category 140, and places the issue into the best-fit categories. The product category 138 includes a specific product line, a product, a software module, a hardware device, etc. As evaluation takes place, the system 100 automatically monitors, identifies, and flags issue categories in need of additional resources (e.g., IT, computer, peripheral device, etc.) or additional staff to resolve the issue.

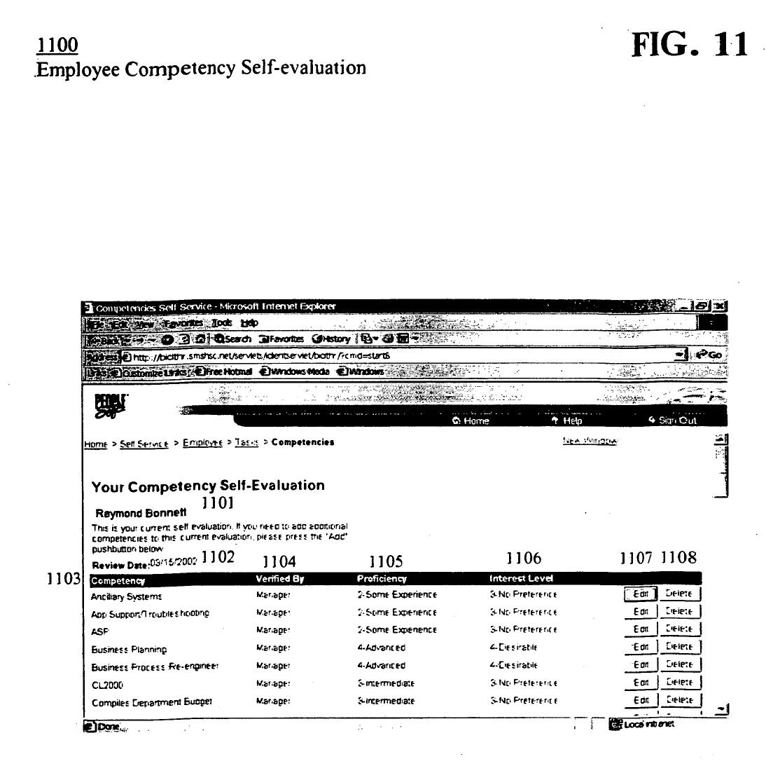

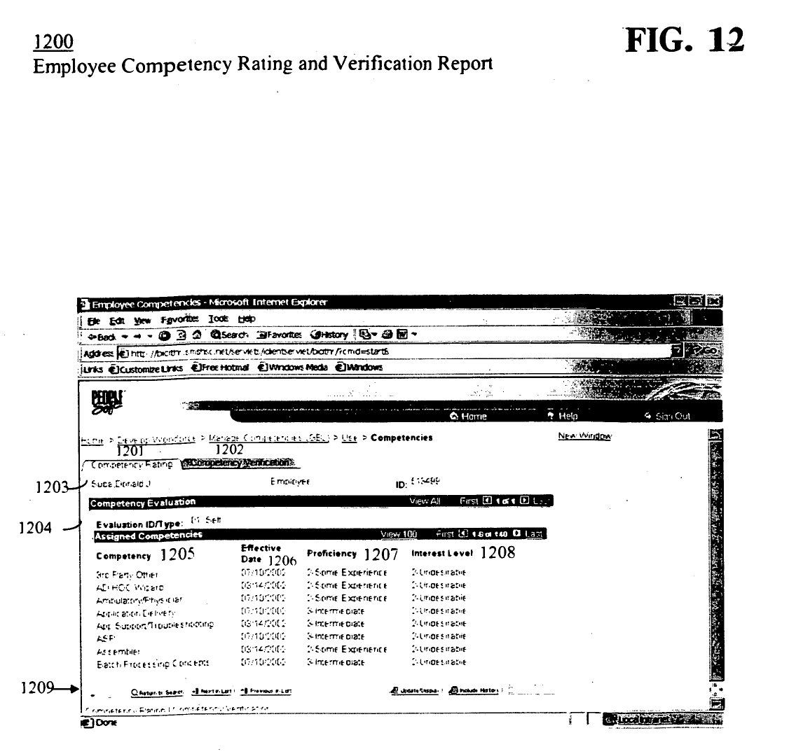

The system 100 maintains human resource reports associating individuals with various items. The reports associate one or more workers with:
a) teams of related individuals, including evaluation of prime time and non-prime time hours of operations;
b) scheduled hours of availability;
c) product categories 138 that the individual is qualified to support, which relates to the product categories that issues are assigned (e.g., by listing the product categories under the worker's competencies, as shown in FIGS. 11 and 12, or otherwise associating the product categories and aspects of the worker, such as the worker's competencies, worker's name, etc.);
d) proficiency level of a worker, which relates to the issue severity category 140 of the issue (e.g., by having the proficiency level of the worker correspond to the issue severity category 140 (e.g., proficiency level one corresponds to issue severity level one), as shown in FIGS. 11 and 12);
e) accumulated issue experience recording cycle times (i.e., turn around time between a worker being assigned an issue and completing an issue), and absolute times (i.e., actual time spent by a worker resolving an issue) for efficient issue resolution, and
f) customer evaluations of issue resolution satisfaction.

The system 100 maintains such association or correspondence in the repository 106.

The system 100 continuously matches the issue workload with the human resources file and looks for imbalanced situations. If there are potential matches across areas of capacity specific displays alerts, and documentation is generated and delivered to the appropriate management for review and staff movement. Alternatively, the task workload is automatically managed by scheduling tasks to be performed by workers via an automatic task scheduling system. If there are no matches, electronic hiring authorizations may be generated (including necessary job descriptions and position titles) and sent to appropriate human resource/staff resources for hiring.

The user interface 110 displays views of the issue workload and the staffing levels can be viewed over user-selected time frames, such as days, weeks, months, quarters and years. For the various product categories, a color-coded graphical display indicates staffing matches with user-defined acceptable operational levels of under and over staffing. Beyond the acceptable operational control limits, color is used to indicate situations needing staff reallocations. A third set of “extreme” limits is used to trigger alerts to the appropriate management chain (set up for each product category).

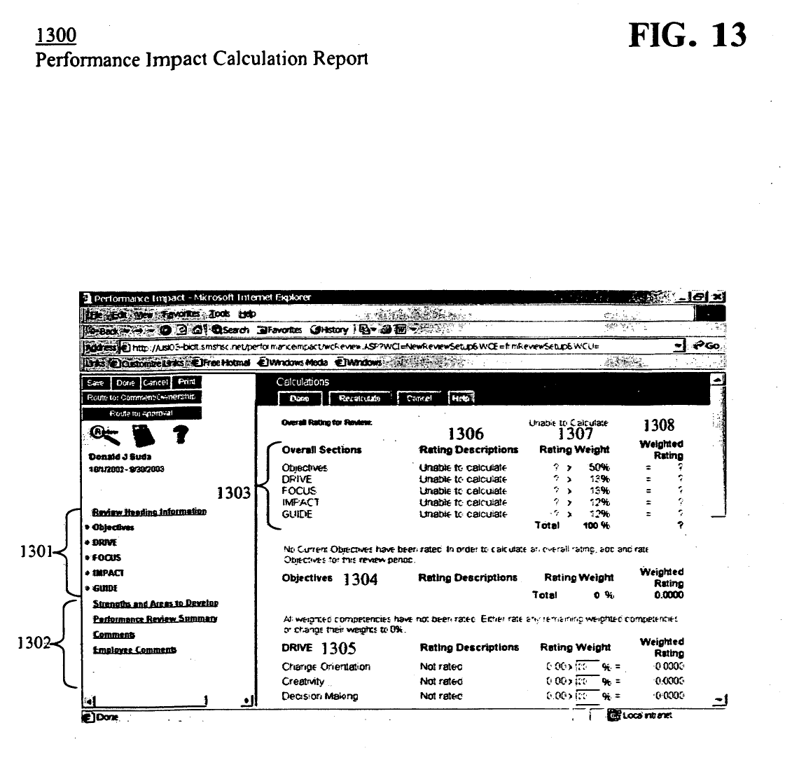

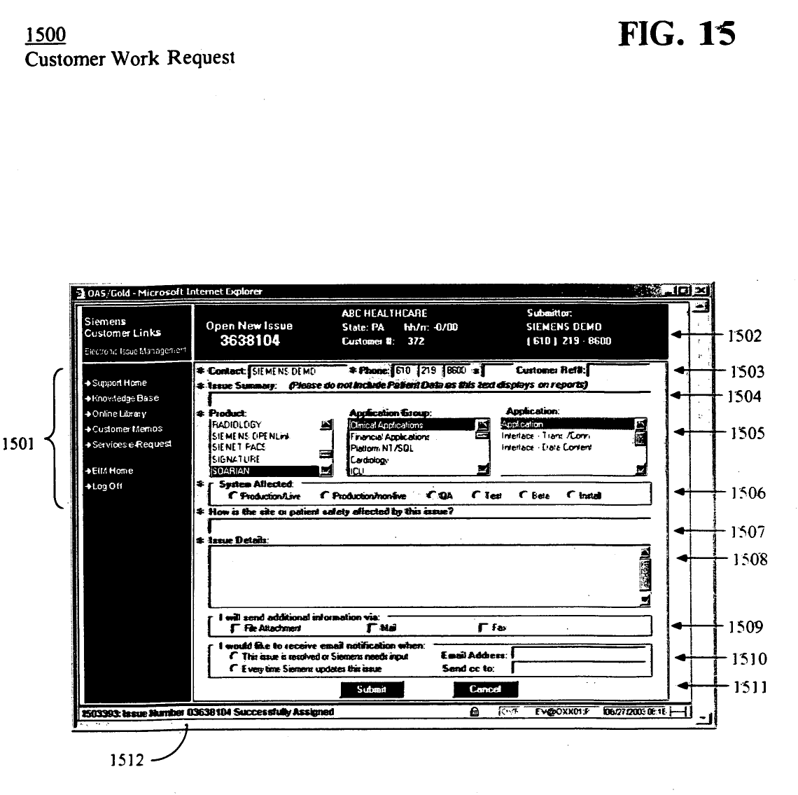

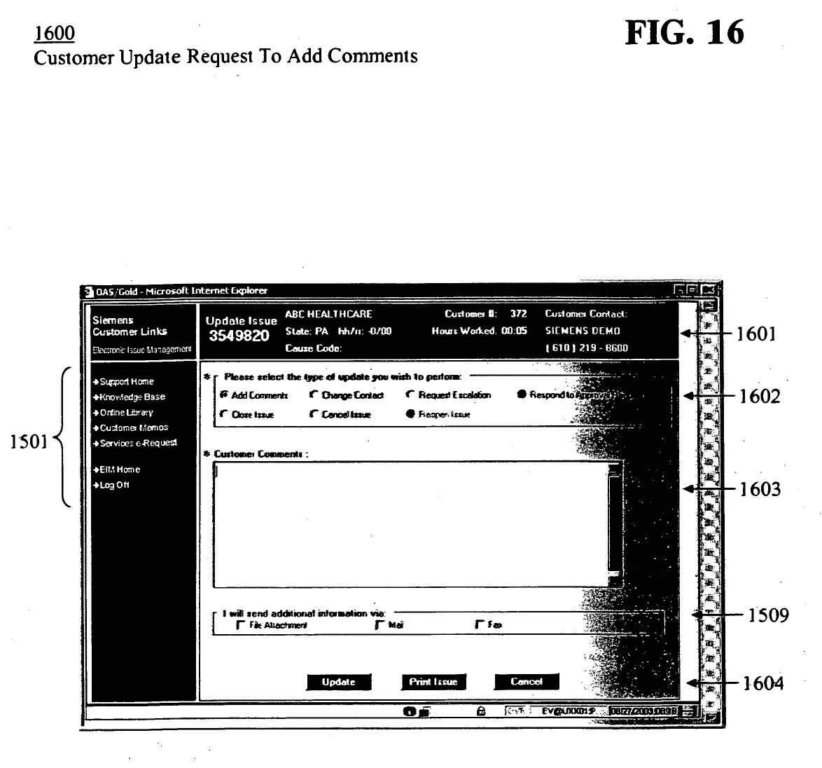

The user interface 110 also enables a user to control the following:
a) upper and lower performance thresholds of the worker's performance impact (e.g. via a rating weight 1307 in FIG. 13),
b) frequency of monitoring and reporting of issue status (e.g., issue resolved or updated via the email notification 1510 in FIG. 15), and
c) automatic movement/reassignment of workers assigned 10 an issue (e.g., via a customer update request to remove a worker from an issue to or have the worker assigned to another issue, which could be employed, but not shown, in FIGS. 16-19 as an update type indicator 1602).

The user interface 110 also enables a user to control the following:
a) historical seasonal workload shift (e.g., payroll year ends);
b) customer and application work load shifts, operational issue input, and staffing levels for input analysis that takes place behind the scenes;
c) issue and staff categorization and severity grading;
d) matching and comparison of load vs. capacity;
e) user interface with variable time windows, multiple levels of control limits with color coded reporting and crisis level alarms to e-mail, fax, etc.
f) historical file of experience; and
g) management reporting of changes in volume per full lime employee (FTE), cycle time, and work time per issue.

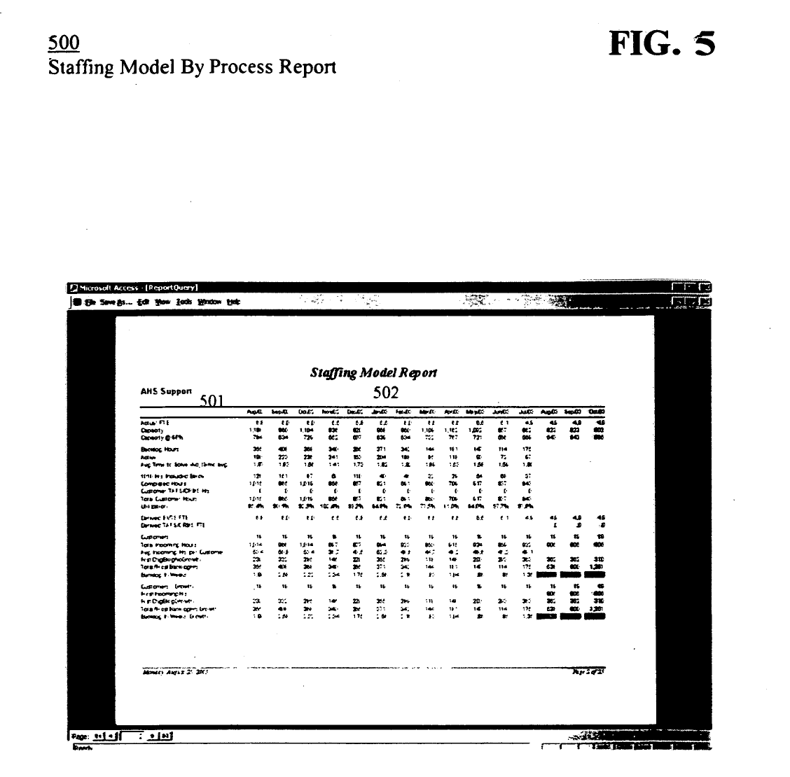

The system 100 advantageously:
a) provides the ability to predict resource needs before the actual need arises (e.g., via a staffing model report 500, shown in FIG. 5);
b) removes personal interest and subjectivity from the analysis, and
c) provides a mechanism for this to occur automatically and in real-time mode.

The system 100 is applicable in industries where reallocation of resources is required to meet business needs in an operational capacity. For example, in manufacturing in order to evaluate incoming needs by associating an available skill set/capacity and issues, and by providing automatic/electronic recommendations on actions/resource movement.

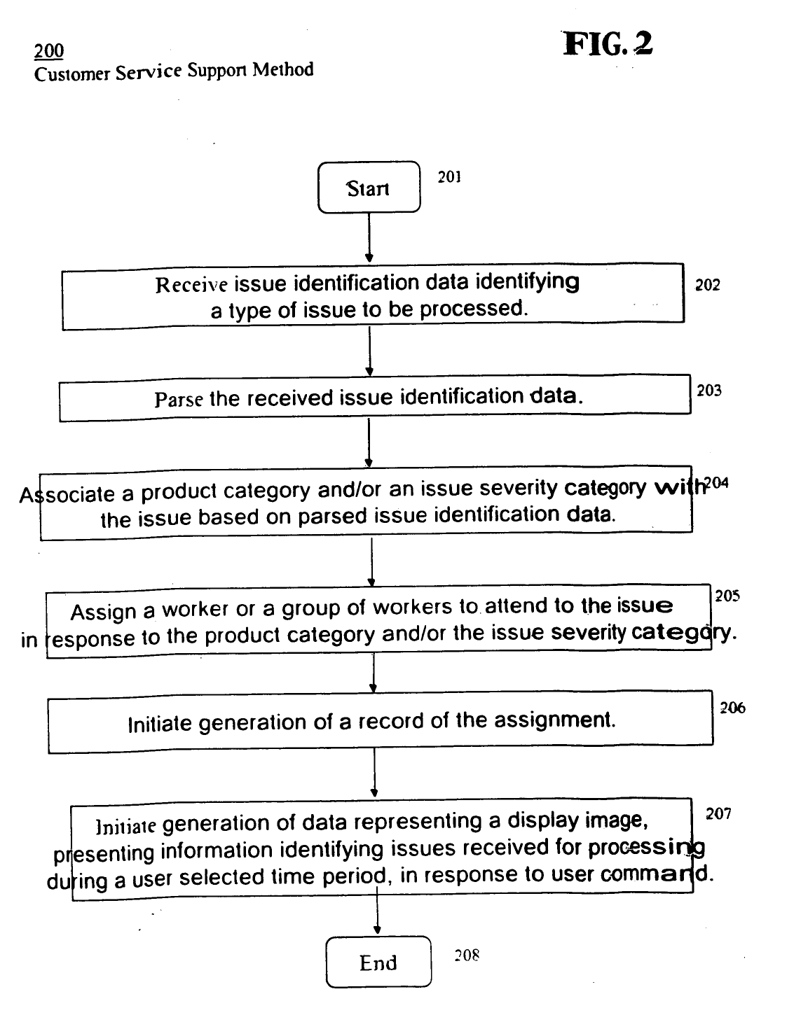

FIG. 2 illustrates a customer service support method 200 for any system, such as the system 100, as shown in FIG. 1. The system 100 may perform other steps in addition to or as a substitute for the steps described in FIG. 2, as described herein.

At step 201, the method 200 starts.

At step 202, the input processor 102 receives the issue identification data 120 identifying a type of issue to be processed.

At step 203, the issue processor 104 parses the received issue identification data 122.

At step 204, the issue processor 104 associates the product category 138 and/or the issue severity category 140 with the issue based on parsed issue identification data.

At step 205, the task scheduling processor 108 assigns a worker or a group of workers to attend to the issue in response to the product category 138 and/or the issue severity category 140.

At step 206, the task scheduling processor 108 initiates generation of a record of the assignment 128.

At step 207, the display generator 116 initiates generation of data representing a display image, presenting information identifying issues received for processing during a user selected time period, in response to user command.

At step 208, the method 200 ends.

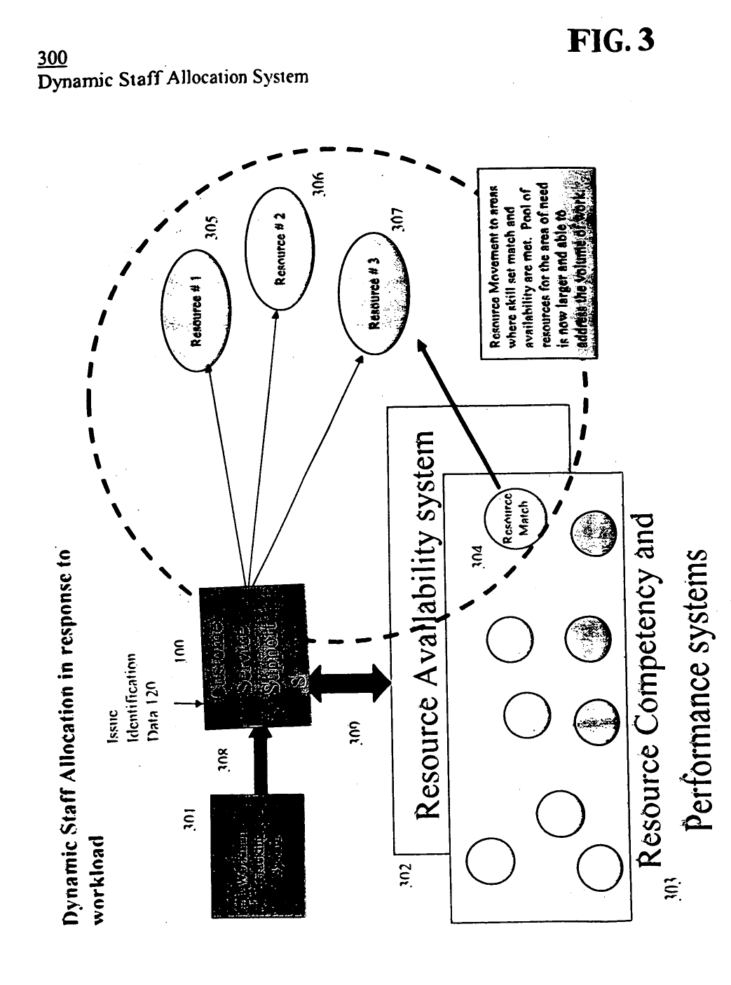

FIG. 3 illustrates a dynamic staff allocation system 300, for example, incorporating the system 100. The dynamic staff allocation system 300 includes the customer service support system 100, as shown in FIG. 1, a workload tracking system 301, a resource availability system 302, resource competency and performance systems 303 including a resource match 304, and resources 305-307.

The workload tracking system 301 generates workload information 308 related to the level and amount of work to be performed by one or more workers. The resource competency and performance systems 303 store, process, and manage the competency and performance of the resources, such as human resources. The resource availability system 302 monitors, determines, and schedules the availability of the resources identified in the resource competency and performance systems 303 to generate resource information 309. The customer service support system 100 receives and processes the issue identification data 120, the workload information 308, and the resource information 309 to efficiently assign the appropriate resources to address the issue. The customer service support system 100 makes an assignment where a skill set for a worker and the availability of the worker matches the need for the issue. Therefore, the customer service support system 100 increases the pool of resources for the area of need to address the volume of work.

The dynamic staff allocation system 300 allocates resources 305-307, such as computer programmer resources, in response to receipt of data 120 identifying an issue for a particular customer. The dynamic staff allocation system 300 is used to allocate one or more workers to handle an individual issue or multiple issues and also to assigns one or more individuals to a group of individuals involved in handling issues received from a customer. The dynamic staff allocation system 300 also is usable in re-assigning an individual from one group to a different group handling issues in response to workload variation.

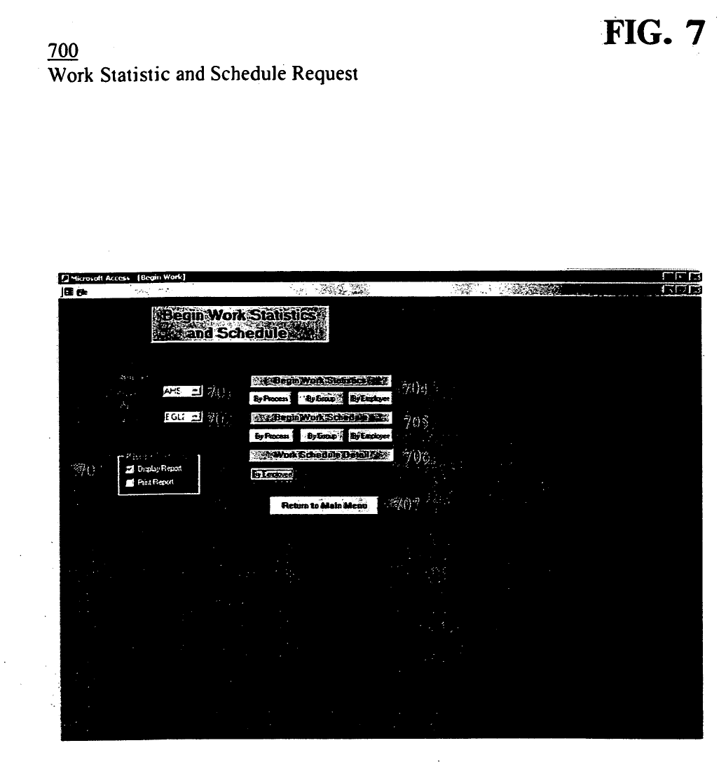

In operation, the dynamic staff allocation system 300 operates as follows and is described with brief references to FIGS. 4-20. A more detailed description of FIGS. 4-20 follows this description.
1. The system 100 receives or retrieves the resource information 309 from the resource availability system 302 to evaluate a staffing model, shown and described in FIGS. 4-6, to identify specific areas where one or more additional resources, such as computer programmers, are required to manage a workload trend.
2. The system 100 receives or retrieves the workload information 308 from the workload tracking system 301 to evaluate workload statistics and schedules, as shown in FIGS. 7-10.
3. The customer service support system 100 receives or retrieves the issue identification data 120, represented as customer work requests, as shown in FIGS. 15-19, to determine what issues, problems, or work needs to be addressed, resolved, or performed, respectively.
4. The system 100 receives or retrieves competency information (e.g., an internal competency database), as shown in FIGS. 11 and 12, from the resource competency system 303, such as one listing worker skill sets, for the core competencies currently residing with one or more workers.
5. The system 100 processes the resource information 309, the workload information 308, the issue identification data 120, and the competency information to determine if there is a match of one or more resources (e.g., workers) to address the issue.
6. When the system 100 determines that there is a match, the system 100 determines the performance impact by identifying a rating of percentage relevance with which their competencies (i.e., skills sets) match those one or more individual workers in a work group. The system 100 sorts a list of workers from a highest percentage match to a lowest percentage match. The system 100 evaluates performance for potential worker matches to assignments or work groups against a human resources performance database to ensure that the workers who may be allocated are performing at an acceptable level.
7. The system 100 assigns one or more workers to the issue responsive to determining a match and responsive to determining an acceptable performance impact.
8. When the system 100 determines that there is not a match (or the number of matches is less than a predefined number of potential matches), the system 100 scans the competency information for one or more workers in other work groups to determine if they have extra work capacity available. The system 100 evaluates the staffing model to identify potential work groups that may have extra work capacity to permit workers to be transferred from the work group having extra work capacity to a work group that needs help with its assigned work.

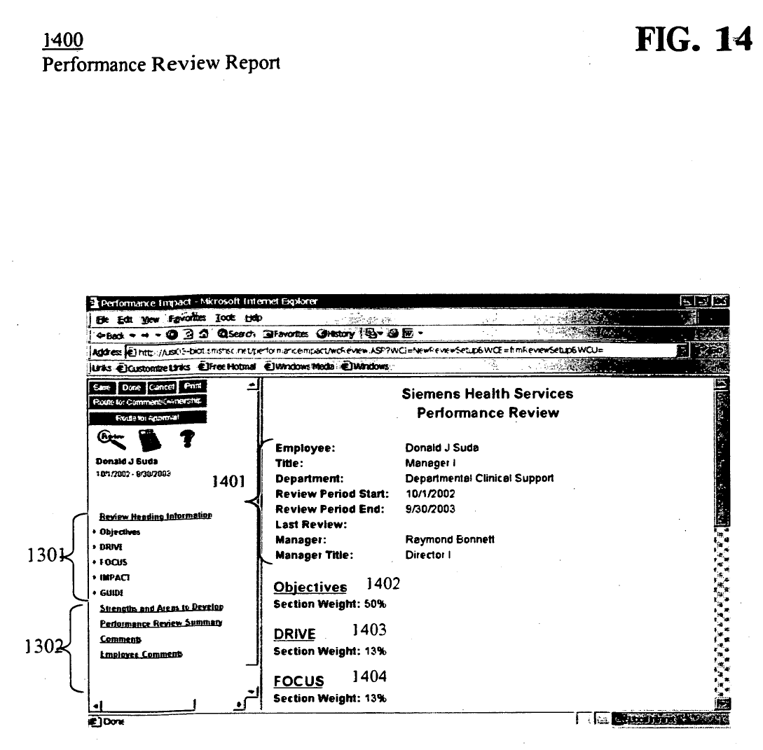

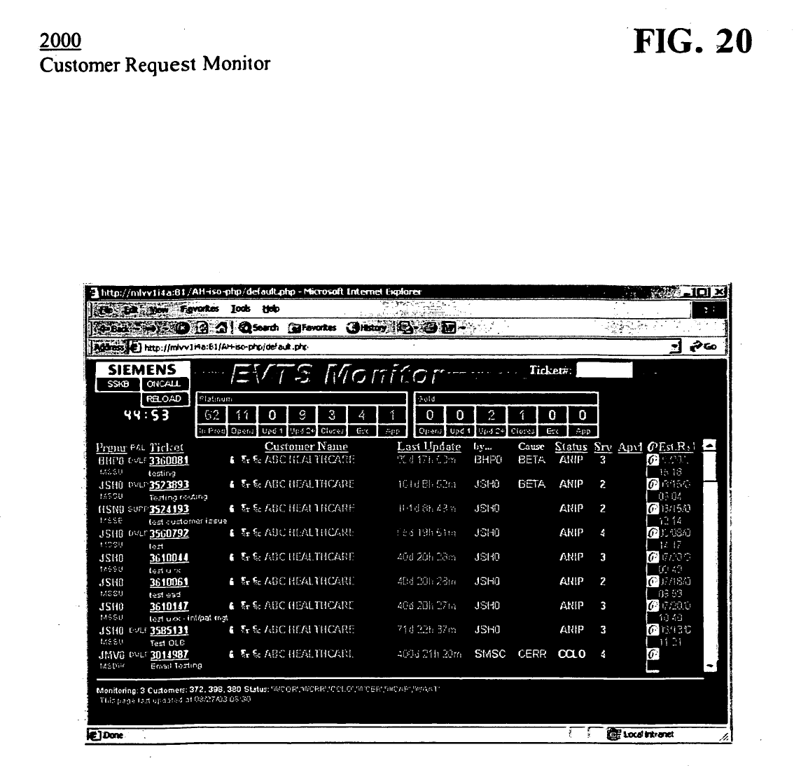

When the system 100 evaluates work groups, the system 100 scans the competency information for workers within those work groups that have been identified as having extra work capacity. The system I 00 determines the performance impact, as shown in FIGS. 13 and 14, for workers within the work groups showing extra work capacity. The system 100 determines the performance impact by identifying a rating of percentage relevance with which their competencies (i.e., skills sets) match those of the workers in the work group that needs help completing their work. The system 100 sorts a list of workers from a highest percentage match to a lowest percentage match. The system 100 evaluates performance for potential worker matches to assignments or work groups against a human resources performance database to ensure that the workers who may be allocated are performing at an acceptable level.
9. If the system 100 determines that workers from other group(s) are available and that the performance impact on the other group(s) is acceptable, then the system 100 assigns the one or more identified workers. Otherwise, if the system 100 determines that either workers from other group(s) are not available or that the performance impact on the other group(s) is not acceptable, then the system 100 notifies the customer (or other party) of the lack of present workers. The system 100 may schedule workers to address the issue at a future time when they become available, or the system 100 may generate a request to acquire additional resources, through hiring, borrowing, or the like, to increase the pool of workers to draw from.
10. The system 100 monitors the status of the customer requests, as shown in FIG. 20. The status may include, for example, assigned, pending assignment, in process, completed, etc.
11. The system 100 communicates information related to the customer requests, such as in the form of alerts, pages, messages, e-mail, or other data, (preferably, automatically and electronically) related to the assignment and management of the resources to a management team responsible for the resource.

FIGS. 4, 5, and 6 relate to the staffing model. The system 100 evaluates the staffing model to identify specific areas where one or more additional workers are required to manage a workload. The system 100 also evaluates the staffing model to identify groups of workers that may have extra work capacity.

FIG. 4 illustrates a staffing model report request 400. The request 400 includes a process selection menu 401, report selection boxes 402-405, and an exit selection box 406. A user of the system 100 inputs a staffing model report request 400 into the system 100 by selecting a process (e.g., select * for all processes) using the process selection menu 401. The process relates to any aspect of the enterprise, such as after hours support (AHS), for example.

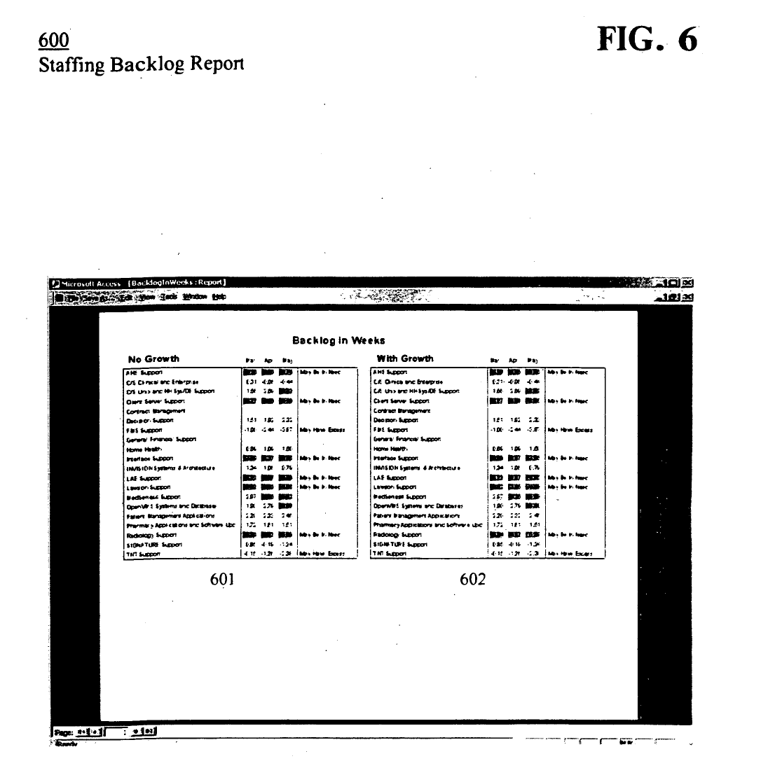

The user also selects one of the following types of report, for example, as desired:
a) staffing model report by process by selecting box 402 to open the report shown in FIG. 5:
b) staffing model report total customer service center (CSC) by selecting box 403 (report details not shown);
c) backlog in week report by selecting box 404 to open the report shown in FIG. 6; and
d) utilization summary by selecting box 405 (report details not shown).

The user selects the exit selection box 406 to exit the staffing model report request 400. The staffing model reports may be communicated to the user by display and/or in print. Therefore, the staffing model report request 400 provides the user with many options for generating resource information 309 (FIG. 3).

FIG. 5 illustrates a staffing model by process report 500. The report 500 includes staffing aspects 501 of the selected process (e.g., AHS) down the left hand side column, and time periods 502 (e.g., by months) across the top row. Therefore, the report 500 provides the user with details of various staffing aspects 501 of the selected, process over various time periods 502.

FIG. 6 illustrates a staffing backlog report 600. The report 600 includes staffing backlog over various time periods (e.g., by weeks) for various processes of the enterprise, assuming no growth in staffing 601 and assuming growth in staffing 602.

FIGS. 7-10 relate to work statistics and schedules represented by workload information 308 received by the system 100 from the workload tracking system 301.

FIG. 7 illustrates a work statistic and schedule request 700. The work statistic and schedule request 700 includes a process selection menu 701, a work group selection menu 702, report viewing options 703, work statistics selection boxes 704, work schedule selection boxes 705, work schedule detail selection boxes 706, and a return to main menu selection box 707.

The process selection menu 701 permits a user of the system 100 to select a process related to the enterprise for a work statistic or schedule. The work group selection menu 702 permits a user of the system 100 to select a work group for the enterprise for a work statistic or schedule. The report viewing options 703 permit a user to view the work statistics or schedule reports by displaying or printing the information. The work statistics selection boxes 704 permit amuser to select the work statistics by process, by group, or by employee, for example. The work schedule detail selection boxes 705 permit a user to select the work schedule by process, by group, or by employee, for example. The work schedule detail selection boxes 706 permit a user to select the work schedule by employee, for example, as well as by process (not shown) and by group (not shown). The return to main menu selection box 707 permits a user to exit the work statistic and schedule request 700 and return to the main menu. Therefore, the work statistic and schedule request 700 provides the user with many options for generating and viewing workload information.

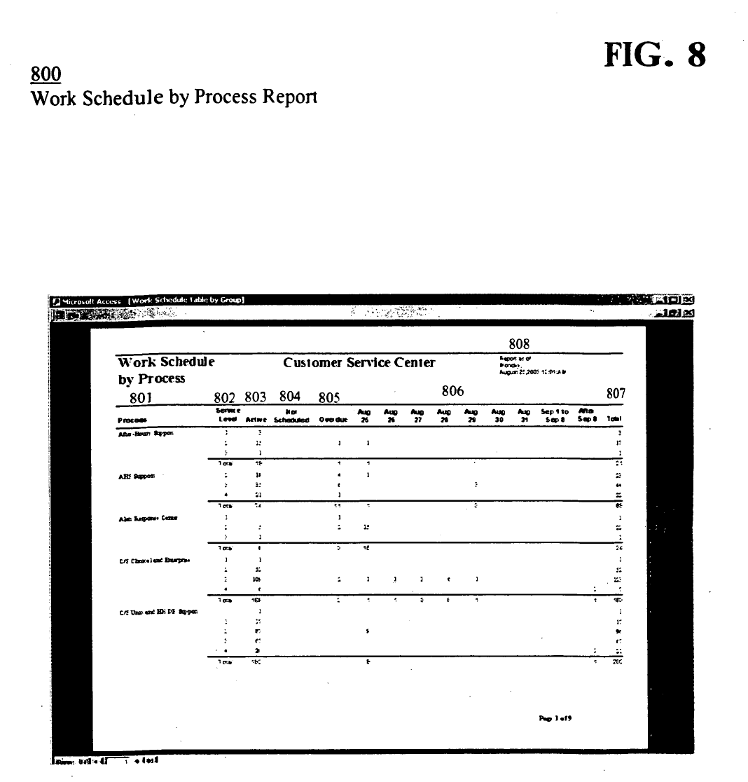

FIG. 8 illustrates a work schedule by process report 800. The work schedule by process report 800 includes processes 801 and corresponding service levels 802, a number of active requests 803, a number of requests not scheduled 804, a number of requests that are overdue 805, various times 806, and a total number of requests 807, and report time information 808.

The processes 801 represent various processes associated with the enterprise. The service levels 802 represent number and levels of service from low or basic (e.g., one) to high or advanced (e.g., four) for a corresponding process 801. The number of active requests 803 represents customer requests presently being worked on by workers. The number of requests not scheduled 804 represent customer requests not yet assigned to a worker. The numbers of requests that are overdue 805 represent customer service requests that have been assigned, scheduled, and the scheduled date has been passed without the work being completed. The various times 806 represent times, such as days, for example, when various customer requests are scheduled to be worked on and/or completed. The total number of requests 807 represents the customer service request that are active 803, not scheduled 804, and overdue for each service level 802 under a corresponding process 801. The report time information 808 represents the day of the week, month, day, year, and time when the work schedule by process report 800 was generated. Therefore, the work schedule by process report 800 provides the user of the system 100 with substantial workload information sorted by process in an understandable format.

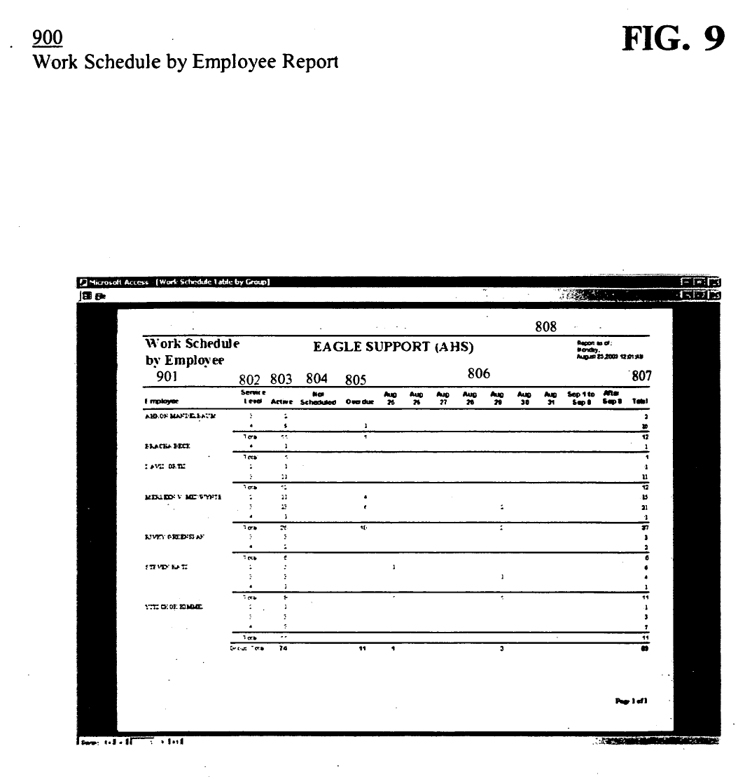

FIG. 9 illustrates a work schedule by employee report 900. The work schedule by employee report 900 includes various employees (or workers) 901. Elements 802-808 in FIG. 9 are the same as those elements shown and described in FIG. 8, except that the reference to processes 801 in FIG. 8 is substituted with a reference to employees in FIG. 9. The work schedule by employee report 900 permits the user or the system 100 to determine which employee should gel the ticket (i.e., the customer request) based on the employee's current workload. Therefore, the work schedule by employee report 900 provides the user of the system 100 with substantial workload information soiled by employee in an understandable format.

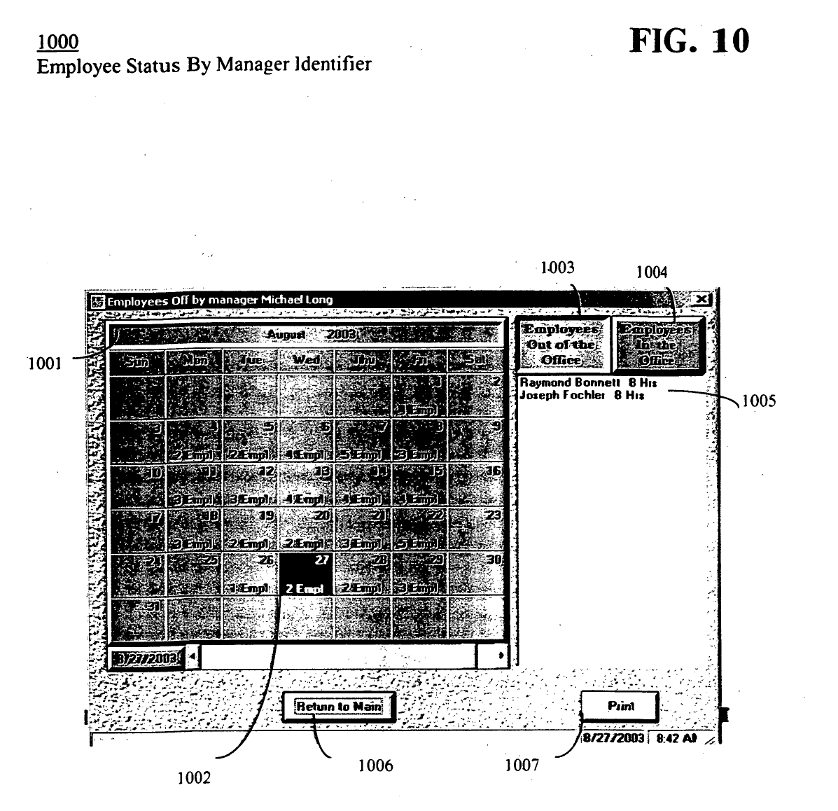

FIG. 10 illustrates an employee status by manager identifier 1000. The employee status by manager identifier 1000 includes a time organizer 1001, a specific time 1002, an employee out of the office selection box 1003, an employee in the office selection box 1004, an employee display area 1005, a return to main menu selection box 1006, and a print selection box 1007.

The time organizer 1001 represents any format for organizing time in a logical and understandable manner, such as a calendar, as shown in FIG. 10. The specific time 1002 represents any format for identifying a specific time in a logical and understandable manner, such as a calendar day, as shown in FIG. 10, and may be selected by the user. The user identifies employees out of the office at the specific time 1002 by selecting the employees out of the office selection box 1003. The user identifies employees in the office at the specific time 1002 by selecting the employees in the office selection box 1004. The employee display area 1005 displays the employees in the office or out of the office at the specific time 1002 responsive to the user selecting the employees out of the office selection box 1003 and the employees in the office selection box 1004, respectively. The user exits the employee status by manager identifier 1000 by selecting the return to main menu selection box 1006. The user prints the employee status by manager identifier 1000 by selecting the print box 1007.

Therefore, the employee status by manager identifier 1000 permits the user to conveniently identify the status of employees according to their manager. The same GUI as shown in FIG. 10 may also be used to identify the status of employees according to other criteria other than their manager. Alternatively, the user may use another GUI conveniently identify the status of employees according to their manager.

FIGS. 11 and 12 relate to the competency of a worker, such as an employee. FIGS. 11 and 12 illustrate how the competency of a worker is loaded into the system 100, and how the competency of a worker is tracked/validated by the system 100 as they develop their skills. The system 100 accesses the competency database to review worker skill sets as needed.

FIG. 11 illustrates an employee competency self-evaluation 1100. The employee competency self-evaluation 1100 includes an employee's name 1101, a review date 1102, competencies 1103 and corresponding verification 1104, proficiency 1105, interest level 1106, an edit selection box 1107, and a delete selection box 1108.

The employee's name 1101 identifies the employee that the self-evaluation pertains to. The review date 1102 identifies the date that the self-evaluation was performed. The employee provides the enterprise with various competencies 1103 (i.e., skill sets). Each of the employee's competencies 1103 is verified 1104 by a third party, such as the employee's manager. Each of the employee's competencies 1103 is rated according to the employee's proficiency 1105 of performing the competencies. The employee indicates their interest level 1106 for each of the employee's competencies 1103. The employee edits a competency 1103 by selecting a corresponding edit selection box 1107. The employee deletes a competency 1103 by selecting a corresponding delete selection box 1108. Therefore, the employee. competency self-evaluation 1100 permits an employee to describe and manage their set of competencies available to the enterprise to permit the system 100 to employ the employee's skills to resolve an issue in an optimum manner.

FIG. 12 illustrates an employee competency rating and verification report 1200. The employee competency rating and verification report 1200 includes a competency rating tab 1201, a competency verification tab 1202, employee identification 1203, an evaluation identification/type 1204, competencies 1205 and corresponding effective dates 1206, proficiencies 1207, interest levels 1208, and selection boxes 1209.

The competency rating tab 1201 permits the user to select information related to an employee's competency rating. The competency verification tab 1202 permits the user to select information related to an employee's competency verification (not shown). The employee's identification 1203 identifies the employee (e.g., name, employment status, identification number) being assessed. The evaluation identification/type 1204 identifies an evaluation code, such as a number, and the type of evaluation, such as self, manager, peer, etc. The employee has various competencies 1205. The effective date 1206 identifies when the employee established, accomplished, or entered the competency 1205. The proficiency 1207 identifies the employee's level of experience in a competency 1205. The interest level 1208 indicates the employee's level of interest in exercising the competency 1205. The selection boxes 1209 permit the user to manage the employee competency rating and verification report 1200, such as by returning to search, advancing to the next competency in the list, advancing to the previous competency in the list, updating the display, including history, etc. Therefore, the competency rating and verification report 1200 permits the user or the system 100 to determine and verify an employee's competency rating.

FIGS. 13 and 14 relate to worker performance. The system 100 evaluates positive matches against the human resource performance database to ensure that the individuals who may be assigned lo an issue are performing at an acceptable level.

FIG. 13 illustrates a performance impact calculation report 1300. The performance impact calculation report 1300 includes heading information selection 1301, other selections 1302, overall sections 1303, an objective section 1304, a drive section 1305, rating descriptions 1306, a rating weight 1307, and a weighted rating 1308.

The heading information selection 1301 describes overall sections, such as objectives, drive, focus, impact, and guide, which affect an employee's performance. The other selections 1302 including strengths and areas to develop, performance review summary, comments, and employee comments permit the user or the system 100 to retrieve additional information on an employee's performance. The system 100 summarizes the employee's performance in the overall sections 1303. The system 100 describes the employee's performance relating to objectives in the objective section 1304. The system 100 describes the employee's performance relating to employee drive in the drive section 1305. Note that the system describes each of the other overall sections, but they are not shown in FIG. 13. The system 100 rates each of the overall sections under the rating descriptions 1306, and gives each of the overall sections a rating weight 1307 to determine a weighted rating 1308. Therefore, the system 100 provides and/or employs objective, quantified, and qualitative descriptions of an employee's performance.

FIG. 14 illustrates a performance review report 1400. The performance review report 1400 includes the heading information selection 1301 and other selections 1302, as shown in FIG. 13, general performance review information 1401, an objectives summary 1402, a drive summary 1403, and a focus summary 1404. The general performance review information 1401 identifies the employee's performance review by descriptions, such as the employee's name, title, department, start and end of review period, last review, manager, and manager's title. The performance review provides summaries of each of the overall sections, such as objectives 1402, drive 1403, focus 1404, impact (not shown), and guide (not shown).

FIGS. 15-19 relate to making an initial customer request and for updating the initial customer request. Generally, a customer makes a request (i.e., opens a ticket) in an electronic issue management (EIM) module, as shown in FIG. 15, and selects a product, application group, and application, as well as electronic routine options. The system 100 automatically routes the ticket to an appropriate queue. The system 100 checks which employees are available (e.g. not on vacation or sick) the day the ticket is opened for issues, such as service level one, which need immediate attention.

FIG. 15 illustrates a customer work request 1500. The customer work request 1500 includes menu selections 1501, header information 1502, customer contact information 1503, a summary of the issue 1504, issue menu selections 1505, a system affected indicator 1506, a customer query field 1507, issue details field 1508, additional information routing indicator 1509, email notification 1510, selection boxes 1511, and a confirmation message 1512.

The menu selections 1501 including, for example, support home, knowledge base, online library, customer memos, services e-request, EIM home, and log off, also shown in FIGS. 16-19, permit a user to navigate the EIM module. The header information 1502 identifies general information related to a customer request including, for example, open new issue, a ticket number, the enterprise's name, the customer's state and identification number, the submitter's name or identification and phone number. The customer contact information 1503 includes, for example, a customer contact, phone number, and reference number. The customer provides a summary of the issue in field 1504. The customer selects a product (e.g., radiology, Siemens® OPENlink®, an application group (e.g., clinical applications, financial applications), and an application (e.g., application, interface—trans/conn., interface—data content) using issue menu selections 1505. The customer indicates which systems may be affected (e.g., production/live, production/non-live, quality assurance, test, beta, install) via the indicator 1506. The customer stales how the issue affects the site or the patient safety by the issue in the customer query field 1507. The customer describes the issue in the issue details field 1 508. The customer indicates how additional information related to the issue will be routed (e.g., file attachment, mail, fax) by selecting the appropriate routing indicator 1509 also shown in FIGS. 16-18. The customer determines when the system 100 should send an email notification (e.g., issue resolved or updated) and to which addresses email information are sent using the email notification 1510. The customer either submits the request or cancels the request by selecting one of the selection boxes 1511. The system 100 generates a confirmation message 1512 including an issue number upon receipt of the customer request in response to the customer selecting the submit selection box 1511. Therefore, the customer work request 1500 permits a customer to electronically enter and submit detailed information about an issue.

FIG. 16 illustrates a customer update request to add comments 1600. The customer update request to add comments 1600 includes header information 1601, update type indicator 1602, a customer comment field 1603, and selection boxes 1604.

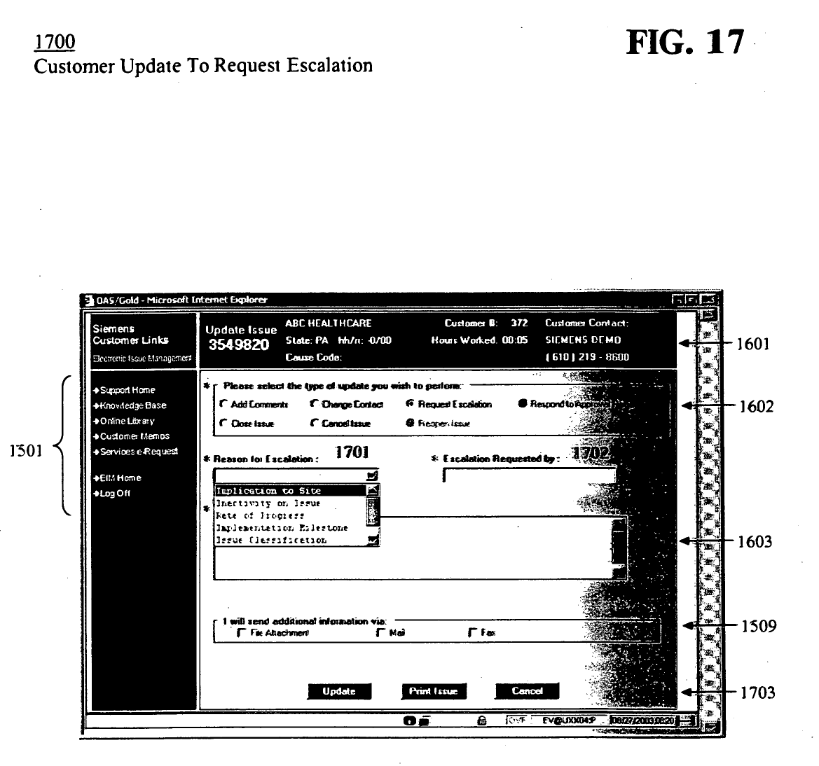

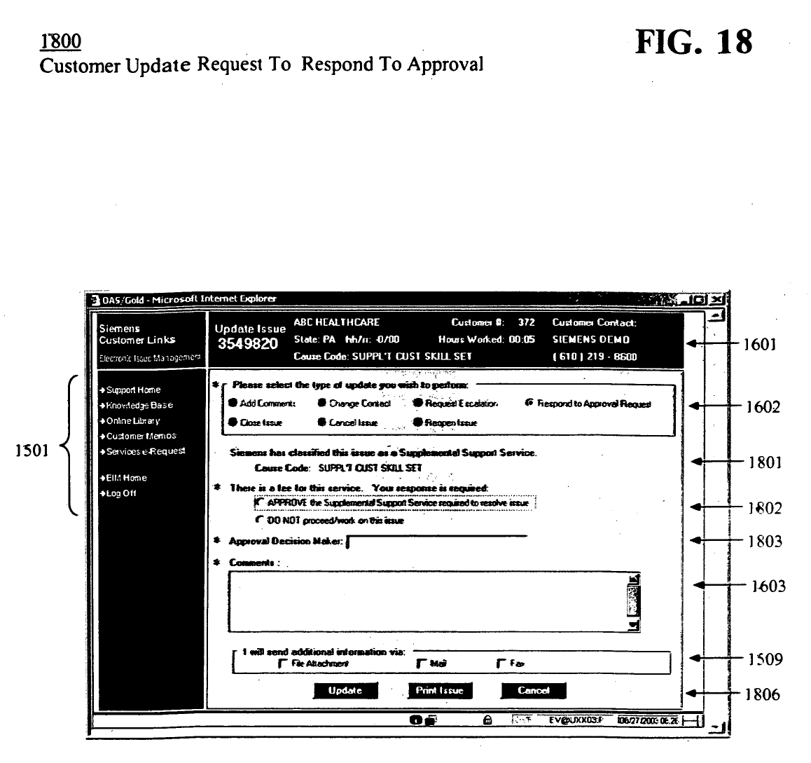

The header information 1601 also shown in FIGS. 17-19, includes the same header information 1502 as in FIG. 15, except for a new update issue number, and the number hours worked on the issue. The customer selects the type of update that they wish to perform (e.g. add comments, close issue, change contact, cancel issue, request escalation, reopen issue, and respond to approval request) by selecting the appropriate update type indicator 1602, also shown in FIGS. 17-19. The customer inputs comments related to the update in the customer comment field 1603, also shown in FIGS. 17 and 18. The customer updates, prints, or cancels the update request by selecting the appropriate selection box 1604, also, shown in FIGS. 17-19.

FIG. 17 illustrates a customer update to request escalation 1700. The customer update to request escalation 1700 includes a reason for escalation menu 1701, a requester field 1702, and selection boxes 1703. The customer selects a reason for escalation (e.g., implication to site, inactivity on issue, rate of progress, etc.) by selecting the appropriate menu 1701. The customer indicates that a particular person made the escalation request in the requester field 1702.

FIG. 18 illustrates a customer update request lo respond to approval 1800. The customer update request to respond to approval 1800 includes a cause code 1801, approval/disapproval indicator 1802, and a decision maker field 1803. The system 100 provides a reason associated with the request for approval (e.g., supplemental customer skill set) under the cause code 1801. The customer approves or disapproves the system request by selecting the appropriate indicator 1802. The customer identifies the person making the decision in the decision maker field 1803.

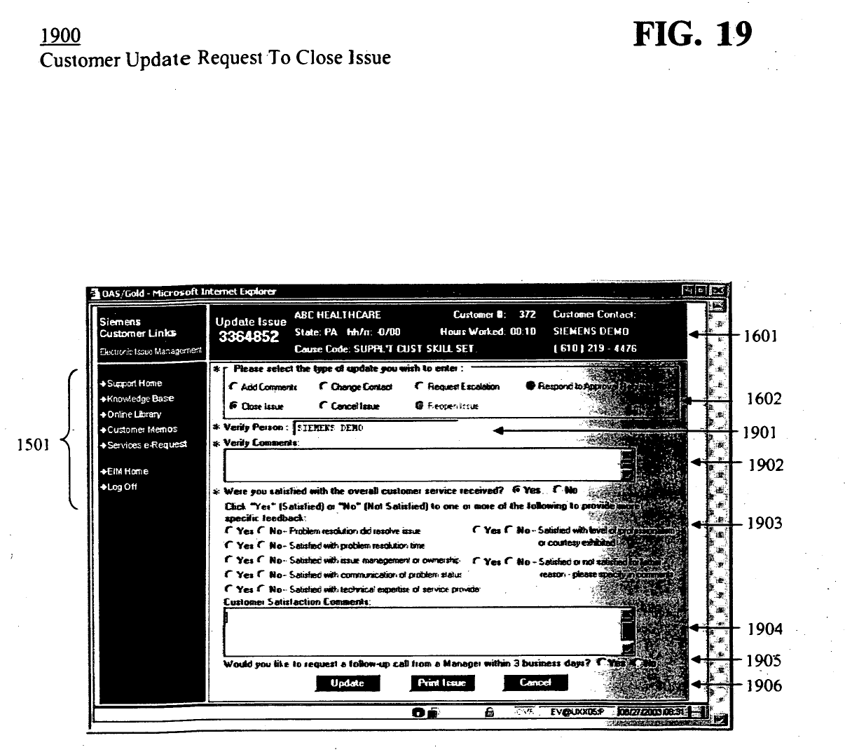

FIG. 19 illustrates a customer update request to close issue 1900. The customer update request to close issue 1900 permits a customer to close issues and permits customer satisfaction feedback. The customer update request to close issue 1900 includes a verify person field 1901, a verify comments field 1902, a customer satisfaction feedback section 1903, a customer satisfaction comment field 1904, and a follow up request indicator 1905.

The customer identifies the person closing the issue in the verify person field 1901. The customer may provide comments related to closing the issue in the verify-comments field 1902. The customer satisfaction feedback section 1903 provides the customer with an opportunity to provide general (e.g., satisfied or not) and specific feedback,(e.g., issue not resolved, not timely, management or ownership, communication, technical expertise, professionalism or courtesy, or other reason) related to the various performance aspects of the service. The customer may provide comments in the customer satisfaction comment field 1904. The customer may request prompt follow up with a manager by selecting the appropriate indicator 1905. Therefore, in FIGS. 15-19 the system 100 advantageously permits a customer to electronically open and update requests to resolve issues.

FIG. 20 illustrates a customer request monitor 2000 permitting a customer or a user of S the system 100 to monitor the status of the customer request. The customer request monitor 2000 includes a ticket number field, an issue summary, and a status description of each issue. The ticket number field permits a customer or a user to search for a particular open ticket number. The issue summary (e.g., platinum or gold service plans) permits a customer or a user of the system 100 to view a summary of the status (e.g., in progress, open, updated, closed, escalated, and approved) of all of the issues. The status description of each issue includes a worker's identification, a ticket number, customer identification, duration of last update, a last update author, a cause, a status, a service level, an approval, and a resolution date.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

1. A system for processing data identifying issues including problems, comprising:
an input processor for receiving issue identification data identifying a type of issue to be processed;
an issue processor for parsing said issue identification data and associating a product category with said issue based on parsed issue identification data; and
a task scheduling processor for assigning a worker to attend to said issue in response to said product category and for initiating generation of a record of said assignment.

2. A system according to claim 1, wherein
said issue processor associates an issue severity category with said issue based on parsed issue identification data, and
said task scheduling processor assigns a worker to attend to said issue in response to said product category and said severity category.

3. A system according to claim 2, wherein said task scheduling processor assigns a particular worker to attend to said issue in response to an indicator representing at least one of, (a) said issue severity category, (b) training of said particular worker. (c) experience of said particular worker, (d) skill of said particular worker, (e) a proficiency level of said particular worker, (f) a schedule of said particular worker. (g) credentials of said particular worker and (h) workload of said particular worker.

4. A system according to claim 2, wherein
said task scheduling processor assigns a particular worker to attend to said issue in response to an indicator representing at least one of, (a) seasonal workload variation, (b) a current time or date and (c) prior successful issue resolution metric of a particular worker.

5. A system according to claim 1, wherein
said task scheduling processor at least one of. (a) stores said generated record of said assignment in memory and (b) communicates said generated record of said assignment to a recipient.

6. A system according to claim 1, wherein
said task scheduling processor automatically updates a task schedule, indicating tasks said worker is responsible for, to indicate said worker is to attend to said issue.

7. A system according to claim 1, wherein
said issue identification data is provided by a customer, and
said issue identification data identifying a type of issue to be processed is received via a network from a customer and comprises data identifying at least one of, (a) a product name, (b) nature of a problem with said product, (c) a type of said product, (d) whether said issue is related to hardware or software, (e) a severity level of said issue, (f) a category identifying impact level on said customer, (g) existence of a warranty held by said customer and associated with said product, (h) a warranty type held by said customer and associated with said product and (i) existence of a service contract held by said customer and associated with said product.

8. A system according to claim 1, wherein
said task scheduling processor assigns a first group of workers to attend to said issue in response to said product category.

9. A system according to claim 8, wherein
said task scheduling processor re-assigns a worker from a second group to said first group in response to said product category.

10. A system for processing data identifying customer issues including problems comprising:
an input processor for receiving issue identification data identifying a type of issue to be processed;
an issue processor for parsing said issue identification data and associating a product category with said issue based on parsed issue identification data; and
a task scheduling processor for dynamically assigning one of a plurality of different workers to attend to said issue in response to said product category and in response at least one of a plurality of different factors and for initiating generation of a record of said assignment.

11. A system according to claim 10, wherein
said plurality of different factors comprise, (a) an indicator representing a number of issues requiring attention, (b) an indicator representing a change in a number of issues requiring attention, (c) an indicator representing a change in severity level of issues, (d) an indicator representing a change in time required to resolve issues, (e) an indicator representing change in skill level of at least one of said plurality of different workers and (f) an indicator representing a seasonal variation.

12. A system according to claim 10, wherein
said plurality of different factors comprise, (a) an indicator representing a change in number of customers and (b) an indicator representing a change in customer activity.

13. A system for dynamically assigning a worker to resolve a customer identified issue, comprising:
a repository containing issue identification data identifying a plurality of individual issues to be processed and associating a product category with an individual issue; and
a task scheduling processor for using said repository in dynamically assigning one of a plurality of different workers to attend to a particular issue in response 1O a product category associated with said particular issue and in response to at least one of,
(a) an indicator associated with a severity level of said particular issue, and
(b) an indicator associated with a proficiency level of a worker.

14. A system according to claim 13, wherein
said task scheduling processor dynamically assigns one of said plurality of different workers to attend to a particular issue in response to at least one of, (i) an indicator associated with a number of issues requiring attention, (ii) an indicator associated with time required to resolve issues and (iii) an indicator associated with seasonal work load variation.

15. A user interface system supporting processing data identifying issues including problems, comprising:
a repository containing issue identification data identifying a plurality of individual issues to be processed and associating a product category with an individual issue;
a task scheduling processor for assigning a worker to attend to an individual issue in response to an associated product category and for initiating generation of a record of said assignment; and
a display generator for initiating generation of data representing a display image presenting information identifying issues received for processing during a user selected time period, in response to user command.

16. A system according to claim 15, wherein
said repository associates an issue severity category with an individual issue, and
said task scheduling processor assigns a worker to attend to said issue in response to said product category and said severity category.

17. A system according to claim 16, wherein
said display generator initiates generation of data representing a display image presenting information identifying issues received for processing together with, at least one of, (a) associated issue severity category information, (b) information identifying a number of workers assigned to attend to said identified issues, (c) information identifying individual workers assigned to attend to said identified issues and (d) information identifying issues collated by associated product category.

18. A system according to claim 16, wherein
said display generator initiates generation of data representing a display image enabling a user to select at least one of. (a) automatic assignment of a worker to attend to an issue. (b) a prompt to a user to initiate assignment of a worker to attend to an issue, (c) a threshold comprising a number of issues for use in triggering issue reassignment and (d) frequency at which a report identifying worker workload is to be generated.

19. A system according to claim 16, wherein
said user selected time period comprises at least one of (a) a day, (b) a week and (c) a month.

20. A method for processing data identifying issues including problems, comprising the steps of:
receiving issue identification data identifying a type of issue to be processed;
parsing said issue identification data;
associating a product category with said issue based on parsed issue identification data;
assigning a worker to attend to said issue in response to said product category; and
initiating generation of a record of said assignment.
